(19) United States
(12) Patent Application Publication
(10) Pub. No.: US 2015/0310779 A1
(43) Pub. Date: Oct. 29, 2015

(54) STRUCTURAL FLAG PANEL ASSEMBLY

(71) Applicants: Frank Louis Raymond, III, Renner, SD (US); Walter Halbleib, JR., Baltic, SD (US); Brad Lee Matthies, Sioux Falls, SD (US)

(72) Inventors: Frank Louis Raymond, III, Renner, SD (US); Walter Halbleib, JR., Baltic, SD (US); Brad Lee Matthies, Sioux Falls, SD (US)

(21) Appl. No.: 14/694,799

(22) Filed: Apr. 23, 2015

Related U.S. Application Data
(60) Provisional application No. 61/983,747, filed on Apr. 24, 2014.

(51) Int. Cl. G09F 17/00

(52) U.S. Cl. CPC G09F 17/00; G09F 2017/0083

(57) ABSTRACT

A structural flag assembly includes a structural flag panel and one or more clamps coupled along a first edge of the structural flag panel. The one or more clamps are movable between open and grasping positions. The one or more clamps couple the structural flag panel to a base object. The structural flag panel extends from a first edge to a second edge. In one example, one or more rotatable joints are coupled between the structural flag panel and the one or more clamps. The structural flag panel is rotatable relative to the one or more clamps and with the one or more rotatable joints. In the grasping position, the one or more clamps are static relative to the base object, and the structural flag panel is free to rotate relative to the one or more clamps.

### CROSS-REFERENCE TO RELATED PATENT DOCUMENTS

This patent application claims the benefit of priority under, 35 U.S.C. Section 119(e), to U.S. Provisional Application Ser. No. 61/983,747 filed on Apr. 24, 2014, entitled SELF SUPPORTING FLAG ASSEMBLY, which is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Raven Industries, Inc. Sioux Falls, S. Dak. All Rights Reserved.

### TECHNICAL FIELD

This document pertains generally, but not by way of limitation, to visible indicia for marking the presence of objects or drawing attention to the indicia.

### BACKGROUND

Visible indicia are used to mark or draw attention to objects. In some examples, visible indicia include textile flags affixed to objects to provide notification that the objects are present. Textile flags include a flexible material that is carried on the wind from an anchor point, for instance on a cable. While the wind is blowing the flag provides a sheet like appearance, sometimes with bright coloration, that reveals the presence of otherwise concealed or difficult to see objects. Accordingly, drivers, pilots, pedestrians, or the like are alerted to the presence of the objects and may accordingly avoid a potential collision.

In some examples, textile flags are coupled along tethering cables used with aerostats (e.g., inflatable bladders that are suspended at altitude above the ground). The textile flags extend from the cable while subject to wind and thereby provide an indication of the presence of the cable.

### OVERVIEW

The present inventors have recognized, among other things, that a problem to be solved can include improving reliable deployment of a flag in poor weather conditions, for instance with little to no wind. For instance, textile flags are flexible and accordingly deploy in a sheet like manner when subject to wind. In calm conditions, the flags fail to fully deploy and instead sag according to gravity. The visual foot print of such a flag is accordingly smaller and thereby limits the attention drawn to the flag.

In an example, the present subject matter can provide a solution to this problem, by providing a structural flag assembly. The structural flag assembly includes a structural flag panel configured to remain deployed throughout the lifetime the flag assembly is coupled with an object, such as an aerostat tether cable, a rod or the like. In one example, the structural flag panel includes a laminant construction having a corrugated structure (inner core) that provides structural integrity to the flag and facilitates constant deployment (presentation) of the flag under any condition, including still conditions. In another example, the structural flag panel is coupled along at least one edge with a frame element. For instance, one or more reinforcing straps and an edge sleeve couple the structural flag panel with the frame element to further strengthen the structural flag assembly. The structural (e.g., rigid) construction of the flag panel ensures the flag is deployed (visible in a fully extended condition) in any condition. Optionally, the corrugations of the structural flag panel extend laterally across the flag, for instance, from the frame element to the opposing edge to substantially minimize retention of water within the flag. Instead, incidental water blown into the corrugations gradually weeps out from the end of the flag remote from the frame element.

The present inventors have recognized, among other things, that a problem to be solved can include minimizing loading of tethers, aerostats and static objects with visible indicia. In some examples, flags, streamers, ribbons or other visible indicia are coupled with cables, aerostat tethers, static objects such as antennas or the like. The indicia are coupled with these objects in a manner that transmits loads experienced by the indicia to the objects. For instance, where textile flags are affixed along aerostat tethers wind forces that cause whipping, loading, spilling of forces and torsion of the flags (and corresponding drag) are transmitted to the tether and accordingly the aerostat. A deployed aerostat may be undesirably moved by these forces. In another example, an aerostat in the process of deployment or retraction is undesirably affected by these forces applied along its tether.

In an example, the present subject matter can provide a solution to this problem, by providing a structural flag assembly rotatably coupled with a base object. As discussed herein, the structural flag assembly includes one or more rotatable joints that facilitate relative rotational movement of the structural flag panel relative to the object. For instance, the structural flag assembly includes one or more rotatable joints that provide a rotating interface between the clamps fixed along a tether cable of an aerostat and a frame element coupled with the structural flag panel. During windy conditions the structural flag panel (and optionally the frame element) are free to rotate relative to the tether. Accordingly, whipping and rotation of the structural flag panel are not transmitted to the tether, and are similarly not transmitted to the aerostat. In contrast to previous tethers including flexible flags coupled along the cable, a tether including the structural flag assembly remains relatively static because the structural flag assembly (or a plurality of assemblies) are free to move relative to the tether. Further, the structural flag assemblies provide wind direction indicators because they are freely rotatable relative to the tether. Where structural flag assemblies are provided at one or more locations along a tether, an operator can easily determine the wind direction at various altitudes between ground level and an aerostat with accuracy. Accurate wind direction information assists with operation, deployment and retraction of the aerostat (e.g., with placement of winches, timing of deployment and retraction, or the like).

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of one example of a structural flag assembly coupled with a base object.

FIG. 2 is a detailed perspective view of the structural flag assembly of FIG. 1 disengaged from the base object with one example of a clamp in an open configuration.

FIG. 3 is a cross sectional view of one example of a laminant structural flag panel having a corrugated structure.

FIG. 4 is a side view of the laminant structural flag panel of FIG. 3 showing a second end with weep orifices.

FIG. 5 is an exploded view of one example of a clamp and a rotatable joint.

FIG. 6 is a detailed cross sectional view at a first edge of the structural flag panel.

FIG. 7 is a schematic view of a plurality of example structural flag assemblies coupled with a tether of an aerostat.

FIG. 8 is a block diagram showing one example of a method of using a structural flag assembly.

### DETAILED DESCRIPTION

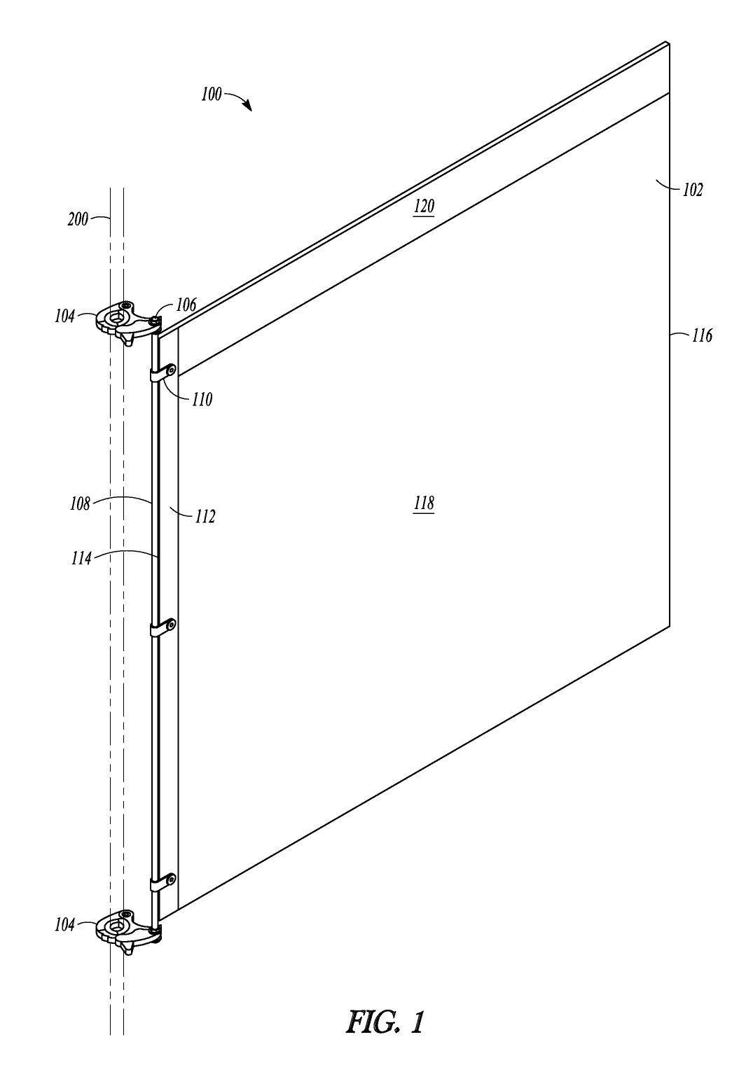

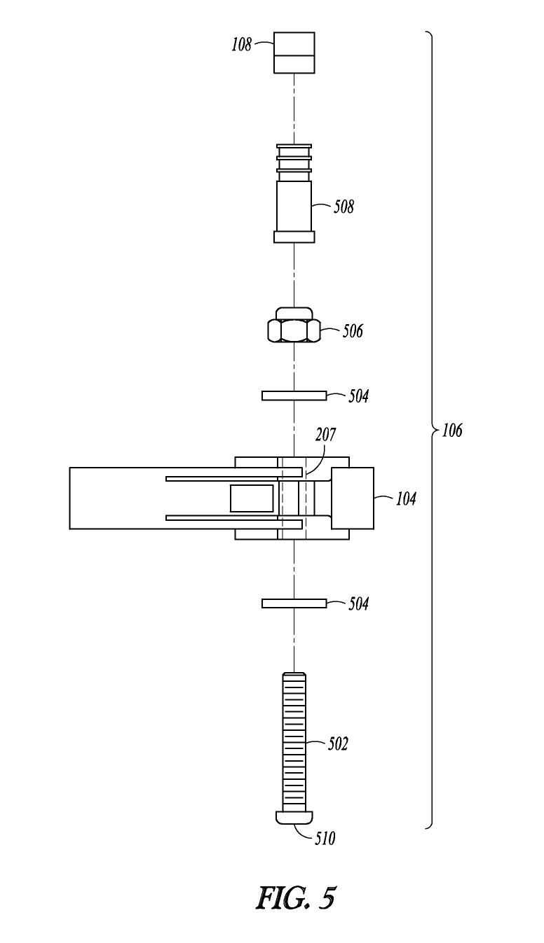

Described herein are various configurations of devices and methods of a marking apparatus, such as a structural flag assembly. The following examples and drawings illustrate the subject matter to enable those skilled in the art to practice the subject matter described in the following detailed description. Portions and features of some examples may be included in, or substituted for, those of other examples. FIG. 1 illustrates a perspective view of one example of a structural flag assembly 100 coupled to a base object 200. As shown, the structural flag assembly 100 includes in the example a structural flag panel 102, at least one clamp 104, and a rotatable joint 106. The structural flag panel 102 is rotatably coupled to the clamp 104. For instance, in one example the structural flag panel 102 includes a rotatable joint, such as the rotatable joint 106 (e.g., a hinge with a pivot and bearing surface that rotates about a pivot axis). The structural flag panel 102 rotates with respect to the at least one clamp 104 (e.g., one, two, three, or four clamps) and the base object 200. In one example, the rotatable joint 106 includes but is not limited to, a screw, at least one washer, a locknut, and a threaded insert, as further detailed in FIG. 5 herein. The optional frame element 108 includes the threaded insert pressed into an end of the frame element 108. The screw is located through an eyelet in the clamp 104 and fastens the clamp 104 to the frame element 108 by engaging with the threaded insert. A washer is located between a head of the screw and the clamp 104 to distribute load or reduce friction. A second washer is located on the opposing side of the clamp 104 between the locknut and the clamp 104. The locknut secures the screw and washers to the clamp 104. The screw has sufficient length to extend beyond the locknut and thread into the threaded insert located at the end of the frame element 108, thereby coupling the clamp 104 to the structural flag assembly 102 (e.g., via the frame element 108).

In one example, the rotatable joint 106 is a hinge that couples a first end of the clamp 104 (e.g., including a first jaw and a second jaw) and a second end (e.g., coupled to the structural flat panel 102.

The clamp 104 grasps the base object 200 to secure the structural flag assembly 100 to the base object 200. In one example, the structural flag assembly 100 includes an optional frame element 108. As shown in FIG. 1, the frame element 108 is coupled to the structural flag panel 102 (e.g., by reinforcing straps 110, an edge sleeve 112, or the like and as further described herein) at a first edge 114 of the structural flag panel 102. Where included in the structural flag assembly 100 the reinforcing straps 110 are coupled to the structural flag panel 102 by fasteners (e.g., rivets, screws, pins, mechanical fittings, adhesives or the like). For instance, each end of the one or more reinforcing straps is coupled to opposing sides of the structural flag panel 102 and extends around the frame element 108.

The structural flag panel 102 includes the first edge 114 and a second edge 116 with two opposing presentation surfaces (e.g., surfaces 118) extending therebetween (e.g., in a parallel fashion). The structural flag panel 102 has a shape including, but not limited to, square, rectangular, triangular, trapezoidal, combinations of the same, or other shapes. In one example, the structural flag panel 102 size is compliant with government regulations for marking objects (e.g., see Federal Aviation Administration regulations requiring each side of a flag marker to be at least 2 feet in length).

The structural flag panel 102 is fabricated from a material that is rigid (e.g., substantially rigid, resistant to deformation or deflection or the like when subject to turbulent wind loading). For instance, the structural flag panel 102 includes, but is not limited to, polyethylene, acrylic, polystyrene foam, or the like. In an example, the structural flag panel 102 substantially holds its shape along the presentation surfaces 118 when exposed to wind loading conditions. Stated another way, during wind loading, at least the presentation surfaces 118 of the structural flag panel 102 resist deflection and accordingly maintain a panel shape (e.g., a flat or planar panel). In another example, the structural flag panel 102 maintains its shape (e.g., as a flat or planar panel) when supported at a single edge of the structural flag panel 102, for instance, while the first edge 114 is coupled along the base object 200.

In one example, the structural flag panel 102 includes, but is not limited to, a material that is conspicuously visible, such as to an intended observer of the structural flag panel 102. In one example, the opposing presentation surfaces 118 (and optionally other features of the assembly 100) are conspicuously visible. The conspicuously visible material includes, but is not limited to, bright colored materials (e.g., orange, red, yellow), a material with a pattern (e.g., checkerboard pattern), a reflective material or the like. In an example, the material includes a material reflective to light waves and detectable with night vision optics (e.g., infrared tape, fabric, lining, sheeting, films or the like), such as light in the infrared or ultraviolet spectrum. In another example, the material is visible to thermal imaging (e.g., thermal tape, fabric, lining, sheeting, films or the like). In one example, the structural flag panel 102 includes a reflective strip 120. The reflective strip is fastened (e.g., by adhesive, rivets, or the like) to the presentation surface 118. The reflective strip 120 includes a material reflective to light waves (e.g., infrared tape, fabric, lining, sheeting, films or the like) and is detectable with night vision optics. In another example, the material of the reflective strip 120 is visible to thermal imaging (e.g., thermal tape, fabric, lining, sheeting, films or the like).

As described above, in one example, the structural flag assembly 100 includes a frame element 108. The frame element 108 is coupled to the first edge 114 of the structural flag panel 102. The frame element 108 supports the structural flag panel 102. For instance, the frame element 108 couples the structural flag panel 102 to the clamps 104, thereby coupling the structural flag panel 102 to the base object 200. Furthermore, the frame element 108 retains its shape when exposed to wind load conditions and optionally provides structural support to the structural flag panel 102. In one example, the frame element 108 is coupled continuously along the first edge 114. In another example, the frame element 108 is coupled at one or more locations including the ends of the first edge 114, at points therebetween or the like. As shown by way of an example in FIG. 1, the frame element 108 is coupled to the structural flag panel 102 with an edge sleeve 112 (the edge sleeve 112 includes, but is not limited to, adhesive tape, fabric, sheeting, plastic or metal clip, or the like). Optionally, at least one reinforcing strap 110 is fastened to the structural flag panel 102 and wraps around one or more of the first edge 114, the edge sleeve 112, and the frame element 108 to maintain the coupling between the structural flag panel 102 and the frame element 108 (where the frame element is included).

The frame element 108 is a solid or hollow member aligned along the first edge 114 of the structural flag panel 102. In an example, the frame element 108 includes, but is not limited to, a tubular cross-section, such as a square, rectangular, circular, hexagonal, or other cross-sectional shape. The material of the frame element 108 includes, but is not limited to, steel, aluminum, carbon fiber, fiberglass, graphite or the like.

In an example, one or more clamps 104 are coupled to the frame element 108, for instance at the ends of the frame element 108, at locations between the ends of the frame element 108, or the like. The frame element 108 includes at least one fitting (e.g., fitting 508, as further shown in FIG. 5 and described herein) for coupling the clamp 104 with the frame element 108. In one example, the fitting is located at the end of the frame element 108. The fitting includes, but is not limited to, a threaded insert, a snap-in feature or insert, an adhesive joint, or a press-fit joint or insert.

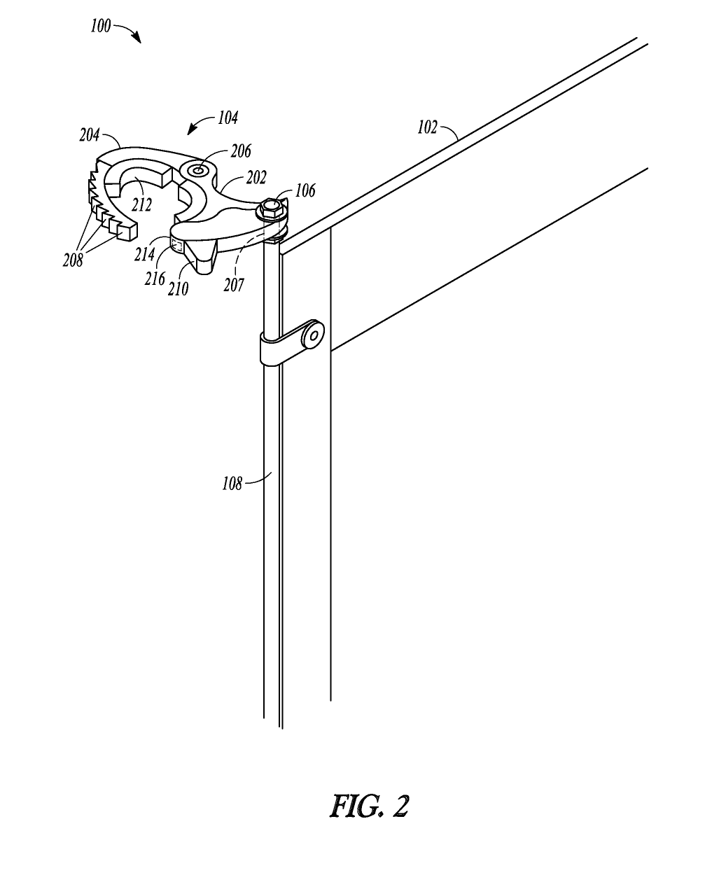

Referring now to FIG. 2, one example of the clamp 104 (shown previously in FIG. 1) includes a first jaw 202 and a second jaw 204 with a jaw hinge 206 therebetween. The jaw hinge 206 couples the first jaw 202 to the second jaw 204. For instance, the first jaw 202 rotates relative to the second jaw 204. As shown in the example of FIG. 2, the clamp 104 is coupled with the structural flag panel 102 (the frame element 108) at a rotatable joint eyelet 207. The rotatable joint 106 is aligned with and rotates around the rotatable joint eyelet 207.

In the example shown in FIG. 2, the first jaw 202 includes a releasable latch 216 (e.g., located on an inward facing surface). The second jaw 204 includes one or more teeth 208 configured to engage with the releasable latch 216 of the first jaw 202 to secure the first jaw 202 to the second jaw 204 and accordingly secure the structural flag assembly 100 along the base object 200. FIG. 2 illustrates an example of the clamp 104 in an open configuration with the first jaw 202 and the second jaw 204 unlatched for reception of the base object 200 therein. In one example, the first jaw 202 includes a latch arm 214. The latch arm 214 is hingedly coupled to the first jaw 202 and includes the releasable latch 216 near one end. For instance, in one example the releasable latch 216 is a lug of material shaped to engage one or more teeth 208. As shown in the example of FIG. 2, the latch arm 214 includes a finger tab 210. In the example shown in FIG. 2, the finger tab 210 is a protrusion allowing an operator to exert force on the finger tab 210. In another example, the finger tab 210 is a notch or depression in the latch arm 214 for an operator to engage the finger tab 210. An operator applies force to the finger tab 210 to pivot the latch arm 214 (and the latch located near the end of the latch arm 214) about the hinged coupling to the first jaw 202, for instance to translate the latch out of engagement with the one or more teeth 208. The clamp 104 grips the base object 200, for instance with engagement of the latch of the first jaw 202 with the teeth 208 of the second jaw 204. In one example, the latch arm 214 includes a cantilever beam. The finger tab 210 and the releasable latch 216 are coupled to the cantilever beam. The releasable latch 216 disengages with the teeth 208 in response to the deflection of the cantilever beam. The amount of deflection of the cantilever beam corresponds to the application of force to the finger tab 210.

As described herein, the base object 200 includes, but is not limited to, a tether (rope or cable) of an aerostat, a tower (e.g., radio tower, water tower), a portion of a crane, an oil rig structure, rod, or the like. Optionally, the first and second jaws 202, 204 include gripping features 212 to assist in grasping of the base object 200 including, but not limited to, knurling, bosses, grooves, or tacky materials such as rubber or the like.

As shown in FIG. 2, for example, the rotatable joint 106 is coupled to the frame element 108. The structural flag panel 102 rotates relative to the base object 200 around the rotatable joint 106. One example of the rotatable joint 106 is shown in detail in FIG. 5 and described herein. Optionally, the frame element 108 also rotates relative to the base object 200. The frame element 108 is fixedly coupled to the structural flag panel 102, and the frame element 108 pivots around the rotatable joint 106 such that the frame element 108 and the structural flag panel 102 rotate relative to the base object 200.

Accordingly, transmission of force to the base object 200 is mitigated by the rotatable joint 106. For instance, only a minimal amount of the force or torsion generated from whipping or rotation of the structural flag panel 102 is transferred to the base object 200. Furthermore, the structural flag assembly 100 provides an indication of wind direction. For instance, the structural flag panel 102 is freely rotatable relative to the base object 200. When wind applies pressure to the presentation surface 118 of the structural flag panel 102, the orientation of the structural flag panel 102 is aligned with the wind direction by the way of the rotatable joint 106, for instance as a weather vane. Stated another way, the structural flag panel 102 is not constrained from rotating according to wind direction by a fixed coupling (e.g., non-rotatable) to the base object.

In one example, the rotatable joint 106 is coupled to the structural flag panel 102 with a direct coupling. For instance, the rotatable joint 106 includes a bracket mounted to the structural flag panel 102. The bracket is coupled to the structural flag panel with fasteners including, but not limited to, rivets, screws, pins, mechanical fittings, adhesives, welds or the like. The bracket includes a channel between two legs for receiving the structural flag panel 102 therein. Optionally, the structural flag panel 102 and the bracket include at least one passage for a fastener to pass through and fix the legs of the bracket around the flag panel 102 to couple the bracket to the structural flag panel 102.

In a further example of the clamp, the clamp 104 includes a rotatable joint 106 that is integrated into the clamp 104. A portion of the clamp 104 is affixed to the structural flag panel 102 and another portion of the clamp 104 includes the first and second jaws 202, 204. The first and second portions of the clamp are coupled together with the rotatable joint 106. That is to say the rotatable joint 106 acts as the pivot between the clamp 104 and the structural flag panel 102 as well as the pivot that facilitates movement between the first and second jaws 202, 204.

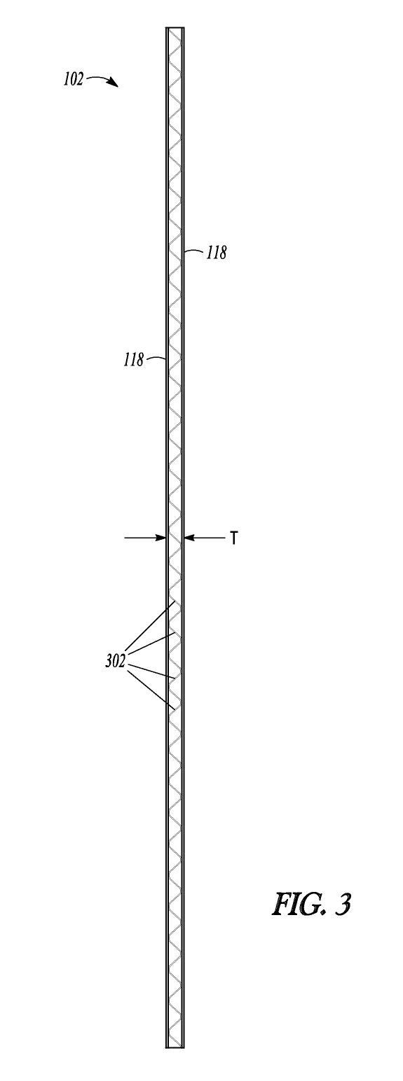

FIG. 3 illustrates an example cross section of the structural flag panel 102 cut parallel to the first edge 114 and perpendicular to the presentation surface 118. In one example, the structural flag panel 102 includes a laminant construction. For instance, the laminant construction includes a corrugated structure 302 between the presentation surfaces 118, as shown in FIG. 3. The corrugated structure 302 is coupled to the presentation surfaces (with adhesives, welds or the like. The corrugated structure 302 optionally extends from the first edge 114 toward the second edge 116. For instance, the orientation of the corrugated structure 302 is configured to drain water from the structural flag panel 102 in the manner of a series of drain channels extending toward the second edge 116 from the first edge 114. In some instances, the laminant construction is lighter than solid constructions, thereby reducing the total weight of the structural flag assemblies 100 coupled to the structure 200 (e.g., to minimize the effect on aerostat buoyancy, the pull on a tether, or the like). The corrugated structure 302 optionally increases the strength to weight ratio of the laminant construction and accordingly facilitates rigidity (e.g., a resistance to deflection) that maintains the panel shape of the structural flag panel 102 even while subject to wind loading.

The structural flag panel 102 is rigid (e.g., substantially rigid, resistant to deformation or deflection or the like when subject to turbulent wind loading). For instance, the structural flag panel includes, but is not limited to, polyethylene panels, acrylic panels, polystyrene foam panels, or the like. For instance, the structural flag panel 102 material is water resistant (e.g., the material is substantially resistant to water absorption). In an example, the structural flag panel 102 substantially holds its shape along the presentation surfaces 118 when exposed to wind loading conditions. Stated another way, during wind loading, at least the presentation surfaces 118 of the structural flag panel 102 resist deflection and accordingly maintain a panel shape (e.g., a flat or planar panel). In another example, the structural flag panel 102 maintains its shape (e.g., as a flat or planar panel) when supported at a single edge of the structural flag panel 102, for instance, while the first edge 114 is coupled along the base object 200. The optional corrugated structure 302 provides additional structural support and thereby assists in maintaining the shape of the structural flag panel 102. By maintaining its shape, the structural flag panel 102 remains visible during regular and inclement conditions (high winds), and is also visible when appropriately marked at night.

In one example, the structural flag panel 102 is a laminant material without a corrugated structure 302. For instance, the structural flag panel 102 includes more than one layer of material. Each layer is coupled to at least one other layer by one or more fasteners (e.g., rivets, bolts, adhesive, or the like). In one example each layer is the same material. Optionally, each layer includes differing materials that provide a combination of material properties to the structural flag panel 102. For instance, in one example the presentation surfaces 118 are provided with a UV resistant material to increase the operational lifetime of the flag panel 102 while an inner core layer provides structural integrity to the flag panel 102. In some instances, multiple layers of material provide more strength than a single layer of material with the same overall thickness T.

In yet another example, the structural flag panel 102 has a unitary construction. In this example the structural flag panel 102 is fabricated from a solid material. For instance, the structural flag panel 102 is fabricated from a single sheet or panel of a polymer, composite or the like such as polyethylene, polycarbonate, carbon fiber paneling or the like.

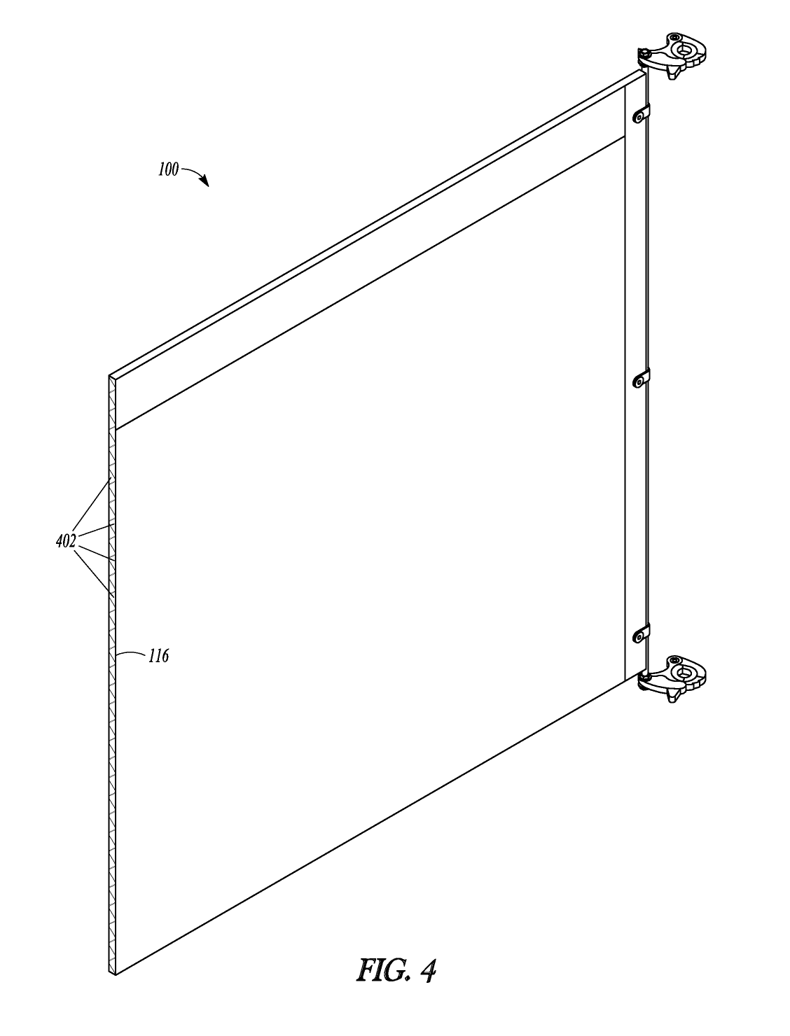

FIG. 4 illustrates an example of a structural flag panel 102 with a corrugated structure 302 including weep orifices 402. As shown in FIG. 4, the weep orifices 402 are located at the second edge 116 of the structural flag panel 102. The weep orifices 402 drain liquids (e.g., rain water) from the structural flag panel 102. For instance, rain water may collect in the corrugated structure during a storm (e.g., the rain is driven into the corrugations). The weep orifices 402 drain water that collects in the corrugated structure 302 of the structural flag panel 102. Draining water from the structural flag panel 102 reduces the weight of the structural flag panel 102, and accordingly minimizes the addition of weight to the base object 200 (and buoyant objects tethered by the base object such as an aerostat).

FIG. 5 illustrates one example of the clamp 104 and the rotatable joint 106. As previously described, the structural flag panel 102 is rotatably coupled to the clamp 104 (see FIG. 1). For instance, in one example, the structural flag panel 102 includes a rotatable joint, such as the rotatable joint 106 (e.g., a hinge with a pivot and bearing surface that rotates about a pivot axis). The rotatable joint 106 allows the structural flag panel 102 to rotate with respect to the at least one clamp 104 and the base object 200. As discussed herein rotation of the structural flag panel 102 with respect to one or more of the clamp 104 or base object 200 minimizes the amount of force or torsion that otherwise is transferred to the base object 200 with relative movement of the structural flag panel.

As shown in the exploded view in FIG. 5, in one example, the rotatable joint 106 includes a fastener 502, at least one washer 504, a locknut 506, and a fitting 508. The optional frame element 108 includes the fitting 508 in an end of the frame element 108 (e.g., press fit, welded, adhered or the like). The fastener 502 is located through an eyelet 207 in the clamp 104 and fastens the clamp 104 to the frame element 108 by engaging with the fitting 508.

In one example, the fitting 508 includes an outer surface for engaging (e.g., by way of a snap-in feature, an adhesive joint, or a press-fit joint) with the frame element 108 and a second surface (e.g., a threaded bore for engaging with the fastener 502). A washer 504 is located between a head 510 of the fastener 502 (e.g., a screw) and the clamp 104 for one or more of load distribution or friction reduction. A second washer 504 is located on the opposing side of the clamp 104 between the locknut 506 and the clamp 104. The locknut 506 secures the fastener 502 and washers 504 to the clamp 104. The fastener 502 has sufficient length to extend beyond the locknut 506 and thread into the fitting 508 located at the end of the frame element 108, thereby coupling the clamp 104 to the structural flag assembly 102 (e.g., via the frame element 108). The locknut 506 prevents disengagement of the fastener 502 from the fitting 508 during operation.

In one example, the rotatable joint 106 is coupled to the structural flag panel 102 directly. For instance, the rotatable joint 106 includes a bracket coupled with the structural flag panel 102. In one example, the bracket is fastened to the structural flag panel 102 with one or more of rivets, screws, pins, mechanical fittings, adhesives or the like. The bracket includes a channel between two legs for receiving the structural flag panel 102 therein. Optionally, the structural flag panel 102 and the bracket include at least one passage for a fastener to pass through and fix the legs of the bracket around the flag panel 102 to couple the bracket to the structural flag panel 102.

In yet another example, the clamp 104 includes a rotatable joint 106 that is integral to the clamp 104. For instance, a portion of the clamp 104 couples to the structural flag panel 102. A second portion of the rotatable joint 106 couples with a portion of the clamp 104 (e.g., including the first jaw 202 and the second jaw 204). Stated another way, the second portion of the rotatable joint 106 acts as a hinge or rotating joint for portions of the clamp 104, such as the first and second movable jaws 202, 204. Accordingly, the rotatable joint 106 allows for rotation of the movable jaws 202, 204 (for coupling with a base object) and rotation of the structural flag panel 102 relative to the rotatable joint 106.

In still another example, the rotatable joint 106 includes, but is not limited to, a hinge such as a living hinge or other rotatable feature coupled between the clamp 104 and the structural flag panel 102. In the example of a living hinge the rotatable joint 106 includes a deformable material that allows for the rotation of the structural flag panel 102 relative to the clamp 104 (and the base object). One example of a living hinge includes a polymer configured for flexibility such as, but not limited to, polyethylene or polypropylene.

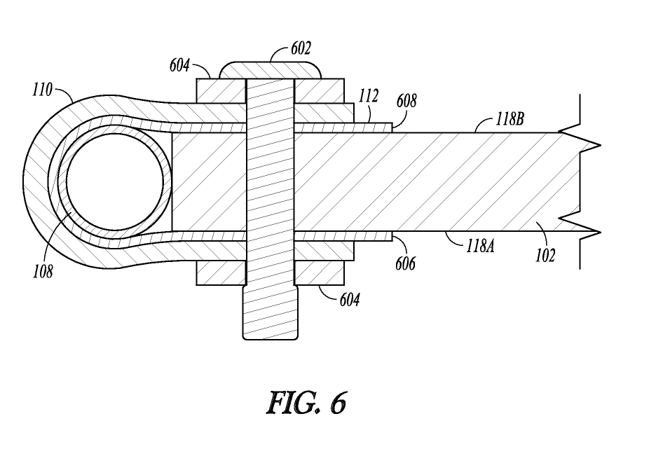

FIG. 6 illustrates a detailed cross sectional view of the structural flag assembly 100 at the first edge 114 of the structural flag panel 102. For instance, the structural flag assembly 100 includes the structural flag panel 102 and one or more optional features. For instance, the structural flag assembly 100, as shown in FIG. 6, includes the frame element 108, the edge sleeve 112, at least one reinforcing strap 110, a fastener 602, and one or more reinforcing strap washers 604. The edge sleeve 112 includes, but is not limited to, an adhesive tape, fabric, sheet or panel, plastic or metal clip, or the like.

In an example, a first edge sleeve end 606 of the edge sleeve 112 is coupled to a first presentation surface 118A. The edge sleeve 112 wraps around the optional frame element 108 and the second edge sleeve end 608 fastens to the second presentation surface 118B as shown in FIG. 6. In the example, the edge sleeve 112 extends along the entire first edge 114 of the structural flag panel (in another example, the edge sleeve 112 is discontinuous). The edge sleeve 112 covers the first edge 114 of the structural flag panel 102 (e.g., partially or completely blocks the entry of water into the first edge 114). The edge sleeve 112 couples the frame element 108 to the structural flag panel 102. As shown in FIG. 6, the edge sleeve 112 is coupled to the structural flag panel 102 with a fastener 602. The fastener 602 includes, but is not limited to, a rivet, screw, pin, mechanical fitting, adhesive, or the like. As shown in FIG. 6, the fastener 602 is a rivet extending through the edge sleeve 112 and the structural panel 102. Optionally, the edge sleeve 112 is coupled to the structural flag panel 102 with adhesive. The edge sleeve 112 provides a continuous surface from the frame element 108 to the first edge 114 that accordingly conceals the first edge 114 from the elements (e.g., rain water). The continuous interface between the frame element 108 and the structural flag panel 102 (along the first edge 114) provided by the edge sleeve 112 reduces drag on the structural flag assembly 100. Optionally, the edge sleeve 112 covers a portion of the first edge 114. For instance, the edge sleeve 112 is coupled at one or more locations of the first edge 114, including, but not limited to, the ends of the first edge 114.

Referring again to FIG. 6, the reinforcing strap 110 is coupled to the structural flag panel 102 at the first edge 114. For instance, the reinforcing strap 110 wraps around the frame element 108 and is coupled to the first presentation surface 118A and the second presentation surface 118B. As discussed herein, the reinforcing strap 110 couples the structural flag panel 102 to the frame element 108. Optionally, the edge sleeve 112 couples the structural flag panel 102 to the frame element 108 and forms a joint, and the reinforcing strap 110 provides additional support to the joint. The reinforcing strap 110 assists in retaining the structural flag panel 102 to the frame element 108 in wind loading conditions. The reinforcing strap 110 includes, but is not limited to a fabric (e.g., polyamide webbing), a sheet or panel, a clip (e.g., metal or plastic) or the like. The reinforcing strap 110 is coupled to the structural flag panel 102 by the fastener 602. Optionally, a reinforcing strap washer 604 separates the fastener 602 from the reinforcing strap 110. The reinforcing strap washer 604 distributes load applied to the reinforcing strap 110 (and the underlying structural flag panel 102) by the fastener 602. Distributing the load applied to the reinforcing strap 110 by the fastener 602 reduces wear on the reinforcing strap 110, the edge sleeve 112 and the structural flag panel 102 to extend the life span of these features.

In one example, the edge sleeve 112 does not wrap around the frame element 108. Rather, the edge sleeve 112 wraps around the first edge 114. For instance, the edge sleeve 112 covers the first edge 114 of the structural flag panel 102 (e.g., partially or completely blocks the entry of water into the first edge 114). Optionally, the edge sleeve 112 covers a portion of the first edge 114. For instance, the edge sleeve 112 is discontinuous and is coupled at one or more locations along the first edge 114, including, but not limited to, the ends of the first edge 114.

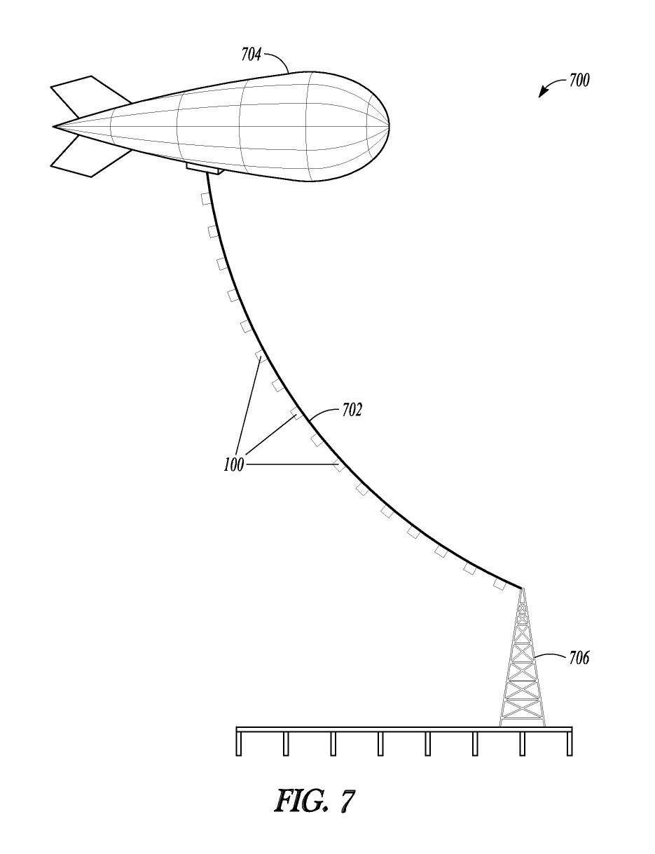

FIG. 7 illustrates a schematic 700 of a plurality of structural flag assemblies 100 coupled to a base object 200 (as shown in FIG. 1), e.g., a tether 702 of an aerostat 704. The structural flag assemblies 100 are each coupled to the tether 702 by at least one clamp 104, respectively. The tether 702 couples the aerostat 704 to a platform 706. The tether 702 includes, but is not limited to, a cable, rope, or the like. The aerostat 704 includes is lighter than air and suspended above the ground. The tether 702 maintains the altitude and location of the aerostat 704 by coupling the aerostat 704 to the ground via the platform 706. The structural flag assemblies 100 provide visual indicia of the location of the tether 702 and warning to pilots (e.g., fixed wing or helicopter pilots) for collision avoidance with the tether 702.

In one example, the structural flag panel 102 includes a construction that provides structural integrity and facilitates consistent deployment (presentation) of the presentation surface 118 under substantially any condition, including no-wind (still) conditions. The structural (e.g., rigid) construction of the structural flag panel 102 is resistant to deformation, maintains the panel in a desired shape and ensures the structural flag panel 102 is deployed (visible in a fully extended configuration) in substantially any conditions.

Each of the structural flag assemblies 100 provides an indication of the wind direction at the location (e.g., altitude) at which the respective structural flag assemblies 100 are positioned on the tether 702. For instance, the structural flag panel 102 at a first altitude rotates with respect to the tether 702 in response to wind loading in the manner of a weather vane. A second structural flag panel 102 (e.g., at a higher or lower altitude along the tether 702) rotates according to wind loading at that altitude and may accordingly indicate a different wind direction at that altitude. Stated another way, each structural flag panel 102 orients to the wind direction at the altitude it is coupled to the tether 702. Where structural flag assemblies 100 are provided at one or more locations along a tether 702, an operator or pilot easily determines the wind direction at various altitudes between ground level and an aerostat 704 with accuracy. Accurate wind direction information assists with operation, deployment and retraction of the aerostat 704 (e.g., with placement of winches, timing of deployment and retraction, or the like).

The rotatable joint 106, structural flag panel 102, and weep orifices 402 lower one or more of the drag or weight of the structural flag assembly 100, thereby reducing forces incident on the tether 702. Lower drag reduces the effect of wind on the position of the aerostat 704. For instance, the structural flag panel 102 rotates (e.g., by the rotatable joint 106) to an orientation having a minimized profile when exposed to wind. The effect of turbulent airflow over the structural flag panel 102 is reduced by the rigid configuration of the structural flag panel 102 as well as the rotatable joint 106. Stated another way, whipping of a deformable flag membrane (often transmitted to a cable) is minimized. Furthermore, the weep orifices 402 of the structural flag panel 102 reduce the weight of the structural flag assembly 100 by draining water from the structural flag panel 102. Water weight, otherwise retained by a flag is thereby not transmitted to the tether 702 and the aerostat 704. Accordingly, whipping, rotation of the structural flag panel 102, corresponding torque, and a saturated weight (due to moisture) are not transmitted to the tether 702 or the aerostat 704. By minimizing the effects of these forces and torque, the position of the aerostat 704 (and the tether 702) is maintained closer to the desired location.

In one example, deploying the aerostat 704 is conducted at increased speed by coupling the structural flag assemblies 100 to the tether 702 with the clamp 104 (e.g., quick release clamp shown in FIGS. 1 and 2) as the tether 702 is deployed. The clamp 104 eliminates the need for tools to couple the structural flag assembly 100 to the tether 702. Furthermore, the attachment of the structural flag assembly 100 to the tether 702 is possible with a single operator. In another example, the structural flag assembly 100 is quickly replaced, for instance when the structural flag assembly 100 becomes damaged or worn.

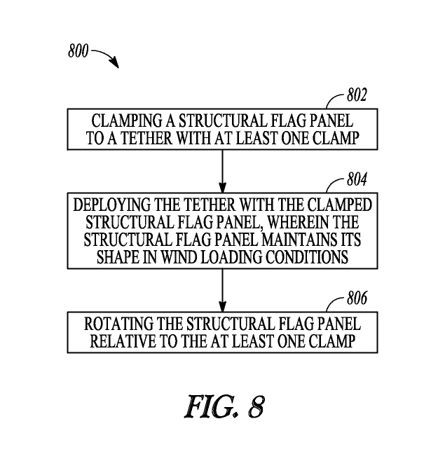

FIG. 8 shows a block diagram of an example method 800 of using the structural flag assembly 100. For instance, the flow chart shows the method 800 for using the structural flag assembly 100 on a base object, such as the tether 702 of the aerostat 704 shown in FIG. 7. At 802, the method 800 includes clamping a structural flag panel 102 (as shown in FIG. 1-7 and described herein) to a base object (e.g., the tether 702) with at least one clamp 104 (e.g., one, two, three, or four clamps). In one example, the clamp 104 (shown previously in FIGS. 1 and 2) includes a first jaw 202 and a second jaw 204 with a jaw hinge 206 therebetween. The jaw hinge 206 couples the first jaw 202 to the second jaw 204 and allows rotation of the first jaw 202 relative to the second jaw 204.

In one example, an operator couples structural flag panels 102 to the tether 702 each with at least one clamp 104 (e.g., a quick release clamp shown in FIGS. 1 and 2) as the tether 702 is deployed. The clamp 104 mitigates the need for tools to couple the structural flag assembly 100 to the tether 702. Furthermore, the attachment of the structural flag assembly 100 to the tether 702 is conducted with a single operator. In another example, the structural flag assembly 100 is quickly replaced, for instance when the structural flag assembly 100 becomes damaged or worn. The operator removes the damage structural flag assembly 100 (e.g., unclamps it) and replaces it with a new structural flag assembly 100.

As described herein, in one example, the operator engages the latch of the second jaw 204 with the teeth 208 of the first jaw 202 in order to couple the structural flag panel 102 to the tether 702 (a base object). As shown in FIG. 2, the second jaw 204 includes one or more teeth 208 configured to engage with the releasable latch 216 of the first jaw 202 to secure the first jaw 202 to the second jaw 204 and accordingly secure the structural flag assembly 100 along the tether 702. FIG. 2 illustrates an example of the clamp 104 in an open configuration with the first jaw 202 and the second jaw 204 unlatched for reception of the tether 702 or other base object therein. Optionally, the first and second jaws 202, 204 include gripping features (e.g., knurling, tacky inner surfaces, teeth or the like) to assist in grasping of the tether 702. In one example, the latch arm 214 includes a cantilever beam. The finger tab 210 and the releasable latch 216 are coupled to the cantilever beam. The releasable latch 216 can disengage with the teeth 208 in response to the deflection of the cantilever beam. For instance, the operator removes the clamp 104 from the tether 702 by applying force to the finger tab 210 and correspondingly deflecting the cantilever beam and translating the releasable latch 216 out of engagement with the one or more teeth 208.

In one example, the structural flag assembly 100 includes a frame element 108 as previously discuss with regards to FIG. 1. The frame element 108 is coupled to the first edge 114 of the structural flag panel 102 to support the structural flag panel 102. Optionally, the frame element 108 is coupled continuously along the first edge 114. In another option, the frame element 108 is coupled at one or more locations including the ends of the first edge 114, at points therebetween, or the like. In one example, the frame element 108 is coupled to the structural flag panel 102 with an edge sleeve 112 (e.g., adhesive tape, fabric, sheet or panels, plastic or metal clips or the like). Optionally, at least one reinforcing strap 110 is fastened to the structural flag panel 102 and wraps around one or more of the first edge 114, the edge sleeve 112, and the frame element 108 to maintain the coupling between the structural flag panel 102 and the frame element 108 (if the configuration includes the frame element 108).

At 804, the method 800 includes deploying the tether 702 with the clamped structural flag panel 102 (e.g., one or more structural flag panels), wherein the structural flag panel 102 maintains its shape in wind loading conditions. In one example, the structural flag panel 102 is fabricated from a material that is rigid (e.g., substantially rigid, resistant to deformation or deflection or the like when subject to turbulent wind loading). For instance, the structural flag panel 102 includes, but is not limited to, polyethylene panels, acrylic, polystyrene foam, or the like. In an example, the structural flag panel 102 maintains its shape along the presentation surfaces 118 (See FIG. 1) when exposed to wind loading conditions. Stated another way, during wind loading, at least the presentation surfaces 118 of the structural flag panel 102 resist deflection and accordingly maintain a panel shape (e.g., a flat or planar panel). In another example, the structural flag panel 102 maintains its shape (e.g., as a flat or planar panel) when supported at a single edge of the structural flag panel 102, for instance, while the first edge 114 is coupled along the base object 200 (e.g., the tether 702).

In another example, the structural flag panel 102 includes, but is not limited to, a material that is conspicuously visible, such as to an intended observer (e.g., operator or pilot) of the structural flag panel 102. In one example, the opposing presentation surfaces 118 (and optionally other features of the assembly 100) are conspicuously visible. The conspicuously visible material includes, but is not limited to, bright colored materials (e.g., orange, red, yellow), a material with a pattern (e.g., checkerboard pattern), a reflective material or the like. In an example, the material includes a material reflective to light waves detectable to night vision optics (e.g., infrared tape, fabric, lining, sheeting, films or the like), such as light in the infrared or ultraviolet spectrum. In another example, the material is visible to thermal imaging (e.g., thermal tape, fabric, lining, sheeting, films or the like). In one example, the structural flag panel 102 includes a reflective strip 120. The reflective strip is fastened (e.g., by adhesive, rivets, or the like) to the presentation surface 118. The reflective strip 120 includes a material reflective to light waves (e.g., infrared tape, fabric, lining, sheeting, films or the like) and is detectable with night vision optics. In another example, the material of the reflective strip 120 is visible to thermal imaging (e.g., thermal tape, fabric, lining, sheeting, films or the like).

In a further example, the structural flag panel 102 includes a laminant construction. For instance, the laminant construction includes a material with a corrugated structure 302 as shown and described with regard to FIG. 3. The corrugated structure 302 optionally extends from between the first edge 114 toward the second edge 116. The orientation of the corrugated structure 302 is configured to drain water from the structural flag panel 102. In one example, water drains from the structural flag panel 102 when the structural flag assembly 100 is deployed, for example, when the first edge 114 (along the tether 702 or other base object) is raised at a higher elevation than the second edge 116. In at least some instances, a construction including, but not limited to, one or more of a laminant or corrugated structure 302 is lighter than a corresponding solid construction. In one example, the structural flag panel 102 is a laminant optionally including a corrugated structure 302.

At 806, the method 800 includes rotating the structural flag panel 102 relative to the at least one clamp 104. In one example, a rotatable joint 106 (as shown and described herein in multiple examples) permits the structural flag panel 102 to rotate with regard to the tether 702 (e.g., the base object). As describe herein, the rotatable joint 106 includes, but is not limited to, a two piece joint, living hinge or the like. The structural flag assembly 100 provides an indication of the wind direction at the location at which the structural flag assembly 100 is positioned on the tether 702. For instance, by deploying a structural flag assembly 100 with a rotatable joint 106, the structural flag panel 102 rotates with respect to the tether 702 in response to wind loading. Each structural flag panel 102 orients with the direction of wind at the corresponding altitude the respective structural flag assemblies 100 are coupled to the tether 702. Where structural flag assemblies 100 are provided at one or more locations along a tether 702, an operator or pilot easily determines the wind direction at various altitudes between ground level and an aerostat 704 with accuracy. Accurate wind direction information assists with operation, deployment and retraction of the aerostat 704 (e.g., with placement of winches, timing of deployment and retraction, or the like).

Additionally, the rotatable joint 106 (e.g., a two piece joint, living hinge or the like) mitigates the transmission of torque from the structural flag panels 102 of the structural flag assembly 100. Instead, the panels 102 rotate relative to the clamps 104 and the base object (e.g., tether 702) at the rotatable joints 106 and thereby isolate the base object from the torque otherwise generated with wind loading of a flag fixedly coupled (e.g., non-rotatably) at the base object.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A structural flag assembly configured for coupling with a base object, the structural flag assembly comprising:
a structural flag panel, wherein the structural flag panel includes a structural panel shape extending between first and section edges; and
at least one clamp configured for coupling the structural flag panel to the base object, wherein the at least one clamp transitions between fixed and released configurations:
in the fixed configuration the at least one clamp grasps the base object, and the structural flag panel rotates relative to the at least one clamp and the base object with a rotatable joint; and
in the released configuration the at least one clamp disengages from the base object.

2. The structural flag assembly of claim 1, further comprising a frame element coupled to the structural flag panel at the first edge of the structural flag panel.

3. The structural flag assembly of claim 1, wherein the structural flag panel includes a laminant construction having a corrugated structure.

4. The structural flag assembly of claim 3, wherein the corrugations of the structural flag panel extend between the first edge and second edge towards the second edge, the corrugations configured to drain water from the structural flag panel.

5. The structural flag assembly of claim 1, wherein the structural flag panel includes a material that is conspicuously visible.

6. The structural flag assembly of claim 1, wherein the structural flag panel includes a surface that is conspicuously visible through night-vision optics.

7. The structural flag assembly of claim 1, wherein the structural flag panel includes a rigid shape.

8. The structural flag assembly of claim 1, wherein the one or more clamps include quick-release clamps configured to grasp the base object.

9. The structural flag assembly of claim 1, wherein the one or more clamps include a first jaw configured to secure to a second jaw.

10. The structural flag assembly of claim 1, further comprising an edge sleeve coupled along the first edge of the structural flag panel and the frame element.

11. The structural flag assembly of claim 1, further comprising one or more reinforcing straps, the one or more reinforcing straps coupled to the frame element and the structural flag panel.

12. A structural flag assembly comprising:
a frame element;
a structural flag panel comprising:
first and second opposed panel surfaces each extending from a first edge to a second edge of the structural flag panel;
a coupling feature coupling the structural flag panel to the frame element at the first edge of the structural flag panel; and
at least one clamp configured for fixing the structural flag panel to a base object, and the structural flag panel is rotatably coupled to the at least one clamp such that the structural flag panel rotates relative to the at least one clamp and the base object.

13. The structural flag assembly of claim 12, wherein the structural flag panel includes a laminant construction having a corrugated structure.

14. The structural flag assembly of claim 13, wherein the corrugations of the structural flag panel extend between the first edge and the second edge towards the second edge, the corrugations configured to drain water from the structural flag panel.

15. The structural flag assembly of claim 12, wherein the structural flag panel includes a material that is conspicuously visible.

16. The structural flag assembly of claim 12, wherein the structural flag panel includes a surface that is conspicuously visible through night-vision optics.

17. The structural flag assembly of claim 12, wherein the structural flag panel is configured to rotate relative to the at least one clamp and the base object with a rotatable joint.

18. The structural flag assembly of claim 12, wherein the one or more clamps include quick-release clamps configured to grasp the base object.

19. The structural flag assembly of claim 12, further comprising an edge sleeve coupled along the first edge of the structural flag panel and the frame element.

20. The structural flag assembly of claim 12, further comprising one or more reinforcing straps, the one or more reinforcing straps coupled to the frame element and the structural flag panel.

21. A method of using a structural flag assembly comprising:
clamping a structural flag panel to a tether with at least one clamp, wherein the structural flag panel includes:
first and second opposed panel surfaces each extending from a first edge to a second edge of the structural flag panel; and
deploying the tether with the clamped structural flag panel, wherein the structural flag panel maintains the structural flag panel shape in wind load conditions; and
rotating the structural flag panel relative to the at least one clamp.

22. The method of claim 21, wherein clamping the structural flag panel includes clamping the structural flag panel including a laminant construction having a corrugated structure.

23. The method of claim 22, comprising draining liquid from the structural flag panel including:
orienting corrugations of the structural flag panel toward the second edge, and
raising the first edge relative to the second edge with deploying of the tether.

24. The method of claim 21, wherein clamping the structural flag panel includes clamping a structural flag panel including a conspicuously visible material.

25. The method of claim 21, wherein clamping the structural flag panel includes clamping the structural flag panel including a surface that is conspicuously visible through night-vision optics.

26. The method of claim 21, wherein rotating the structural flag panel relative to the at least one clamp includes rotating at a rotatable joint.

27. The method of claim 21, wherein clamping the structural flag panel includes clamping a structural flag panel configured to include a rigid shape.

28. The method of claim 21, wherein clamping the structural flag panel includes clamping the structural flag panel to the tether with one or more quick-release clamps.

29. The method of claim 21, wherein clamping the structural flag panel includes clamping the tether between first and second jaws.

30. The method of claim 21, wherein clamping the structural flag panel includes clamping the structural flag panel including an edge sleeve along the first edge of the structural flag panel and the frame element.

31. The method of claim 21, wherein clamping the structural flag panel includes coupling one or more reinforcing straps to the frame element and the structural flag panel.
